(19) United States
(12) Patent Application Publication
(10) Pub. No.: US 2006/0047938 A1
(43) Pub. Date: Mar. 2, 2006

(54) Method and apparatus to initialize CPU

(76) Inventors: Soo-hee Park, Suwon-si (KR); Man-suk Park, Seoul (KR)

Correspondence Address: STANZIONE & KIM, LLP, 919 18TH STREET, N.W., SUITE 440, WASHINGTON, DC, 20006, US

(21) Appl. No.: 11/213,775

(22) Filed: Aug. 30, 2005

(30) Foreign Application Priority Data
Aug. 31, 2004 (KR) 2004-69094

(51) Int. Cl. G06F 9/00

(52) U.S. Cl. 713/1

(57) ABSTRACT

A method and apparatus to initialize a central processing unit (CPU). The apparatus includes: the CPU decoding a program command of an electronic device and executing the command; a first memory to store a booting program to boot the electronic device and initialization data to initialize the CPU; and a CPU initialization unit to read the booting program and the initialization data from the first memory and to send the booting program and the initialization data to the CPU, wherein the CPU is initialized by using the initialization data. Accordingly, the apparatus can initialize the CPU without using a memory such as an EEPROM, and hence reduce the manufacturing costs of an electronic device. Further, since a memory such as an EEPROM for initialization of the CPU is not used, and therefore does not need to be programmed, the memory region for the program is not necessary, and therefore the size of a board can be reduced.

### CROSS-REFERENCE TO RELATED APPLICATIONS

This application claims the priority of Korean Patent Application No. 2004-69094, filed on Aug. 31, 2004, in the Korean Intellectual Property Office, the disclosure of which is incorporated herein in its entirety by reference.

### BACKGROUND OF THE INVENTION

1. Field of the Invention

The present general inventive concept relates to a method and apparatus to initialize a central processing unit (CPU), and more particularly, to a method and apparatus to initialize a CPU without using a memory such as an electrical erasable programmable read-only memory (EEPROM).

2. Description of the Related Art

An electrically erasable programmable read-only memory (EEPROM) or a similar memory, which can store initialization data, is required to initialize a central processing unit (CPU). The EEPROM is a read-only memory (ROM) in which data is electrically written and erased. When an electronic device such as a computer is powered up for the first time or re-started, a CPU thereof necessary to be initialized generates a clock signal and sends it to an external EEPROM to obtain required initialization data. In synchronization with the clock signal, the external EEPROM transmits the initialization data stored therein to the CPU.

That is, to be initialized, the CPU requires a memory, such as the EEPROM, storing the initialization data. In addition, the memory has to be programmed in advance. Accordingly, since the external EEPROM must be installed and programmed, the cost of an electronic device can be high.

### SUMMARY OF THE INVENTION

The present general inventive concept provides an apparatus to initialize a central processing unit (CPU) without using an independent memory for storing initialization data.

The present general inventive concept also provides a method of initializing a CPU without using an independent memory for storing initialization data.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an apparatus to initialize a central processing unit (CPU), the apparatus including: the CPU decoding a program command of an electronic device and executing the command, a first memory to store a booting program to boot the electronic device and initialization data to initialize the CPU, and a CPU initialization unit to read the booting program and the initialization data from the first memory and to send the booting program and the initialization data to the CPU, wherein the CPU is initialized by using the initialization data.

The foregoing and/or other aspects and advantages of the present general inventive concept are also achieved by providing a method of initializing a CPU, the method including reading a booting program to boot an electronic device and initialization data to initialize the CPU, which decodes a program command of the electronic device and executes the command, from a first memory and respectively storing the booting program and the initialization data in a second memory and a third memory, sending the initialization data to the CPU in response to a request signal for the initialization data sent from the CPU, and initializing the CPU by using the sent initialization data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of apparatus to initialize a central processing unit (CPU) according to an exemplary embodiment of the present general inventive concept.

FIG. 2 is a block diagram of an example explaining the initialization unit of the CPU of FIG. 1; and

FIG. 3 is a flowchart illustrating a CPU initialization method according to another exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

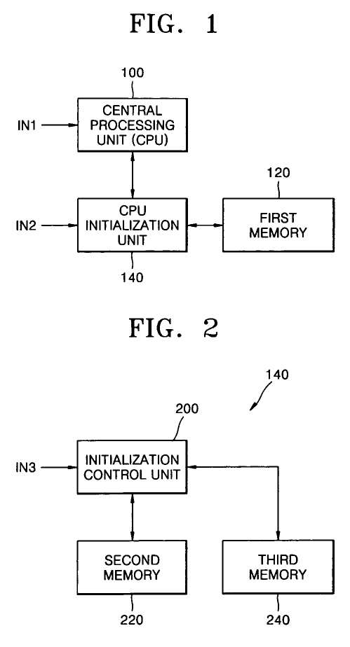

FIG. 1 is a block diagram of apparatus to initialize a central processing unit (CPU) 100 according to an exemplary embodiment of the present general inventive concept. Referring to FIG. 1, the block diagram is formed of a CPU 100, a first memory 120 and a CPU initialization unit 140.

The CPU 100 decodes a program command of an electronic device such as a computer or a computer peripheral device and executes the command. The CPU 100 is the most important part of the electronic device, and controls three main functions, that is, storage, operation and control, in the electronic device.

In response to a request signal for a booting program input via an input terminal IN1, the CPU 100 sends the request signal to the CPU initialization unit 140, and controls the booting of the electronic device according to the booting program received from the CPU initialization unit 140. Further, responding to the request signal also requesting for initialization data input via the input terminal IN1, the CPU 100 sends the request signal for the initialization data to the CPU initialization unit 140, and is initialized by the initialization data sent from the CPU initialization unit 140.

The first memory 120 stores the booting program to boot the electronic device and the initialization data necessary to initialize the CPU 100.

Booting, as a method of inputting a program, is a routine in which a start command is received in a simple operation, and subsequently commands are read and finally the program is fully stored in a memory unit according to the commands. For example, by booting, a memory is cleared, an input/output device is installed, and an operating system is loaded from a read only memory, a disk, or a cassette. A booting program is needed for such booting.

The initialization data is used to initialize the CPU 100.

Conventionally, the booting program and the initialization data are respectively stored in independent memories. That is, the booting program is stored in a memory such as a flash memory; and the initialization data is stored in a memory such as an electrically erasable programmable read-only memory (EEPROM). However, the first memory 120 according to the present general inventive concept stores a booting program together with initialization data. Further, the first memory 120 is a flash memory.

The first memory 120 sends the booting program and the initialization data to the CPU initialization unit 140 which requests the program and the data.

The CPU 140 reads the booting program and the initialization data from the first memory and sends the program and the data to the CPU 100.

The CPU initialization unit 140 operates when power is supplied to the electronic device or when the electronic device starts to work. Specifically, when the CPU initialization unit 140 receives a power signal indicating that power has been supplied via an input terminal IN2, the CPU initialization unit 140 reads the booting program and the initialization data from the first memory 120 and sends the program and the data to the CPU 100. Further, when the CPU initialization unit 140 receives a restart signal indicating that a command to restart the electronic device is received via the input terminal IN2, the CPU initialization unit 140 may read the booting program and the initialization data from the first memory 120 and send the program and the data to the CPU 100.

FIG. 2 is a block diagram further illustrating the CPU initialization unit 140 illustrated in FIG. 1. Referring to FIG. 2, the CPU initialization unit 140 includes an initialization control unit 200, a second memory 220, and a third memory 240.

The initialization control unit 200 reads the booting program and the initialization data from the first memory 120 and controls the booting program and the initialization data to be respectively stored in the second memory 220 and the third memory 240. Further, the initialization control unit 200 controls the initialization data to be sent to the CPU 100 in response to the request signal requesting the initialization data sent from the CPU 100, and controls the booting program to be sent to the CPU 100 in response to the request signal requesting the booting program sent from the CPU 100.

When the initialization control unit 200 receives the power up signal or a restart signal via an input terminal IN3, the initialization control unit 200 sends a read signal requesting the booting program and the initialization data from the first memory 120 in response to the received signal. The first memory 120 sends the booting program and the initialization data stored in the first memory 120 to the CPU initialization unit 140 in response to the read signal received from the initialization unit 200. The initialization control unit 200 controls the received booting program and initialization data to be stored in the second memory 220 and the third memory 240, respectively.

Meanwhile, the initialization control unit 200 controls the initialization data stored in the third memory 240 to be sent to the CPU 100 in response to the request signal requesting the initialization data sent from the CPU 100.

In addition, the initialization control unit 200 controls the booting program stored in the second memory 220 to be sent to the CPU 100 in response to the request signal requesting the booting program sent from the CPU 100. After being initialized by using the initialization data, the CPU 100 sends the request signal requesting the booting program to the initialization control unit 200. The initialization control unit 200 receives the request signal requesting the booting program and controls the booting program stored in the second memory 220 to be sent to the CPU 100, and then booting is performed by the booting program sent to the CPU 100.

The second memory 220 stores the booting program read from the first memory 140 according to the control of the initialization control unit 200. Additionally, the second memory 220 sends the stored booting program to the CPU 100.

The third memory 240 stores the initialization data read from the first memory 140 according to the control of the initialization unit 200. Further, the third memory 240 sends the stored initialization data to the CPU 100.

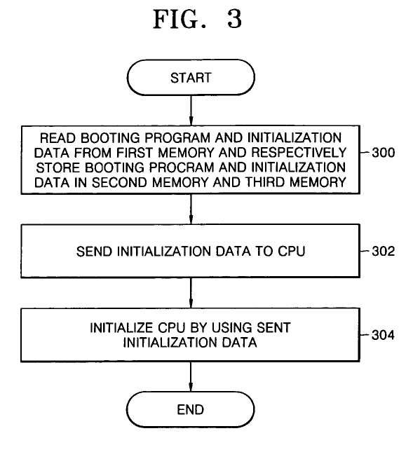

FIG. 3 is a flowchart illustrating a method of initializing a CPU according to an exemplary embodiment of the present general inventive concept.

First, the booting program to boot the electronic device and the initialization data to initialize the CPU 100, which decodes a program command of the electronic device and executes the command, are read from the first memory 120 and are stored to the second memory 220 and the third memory 240, respectively (operation 300).

In contrast with the conventional booting program and the initialization data which are respectively included in separated memories, in the present embodiment, the first memory 120 stores the booting program together with the initialization data. The first memory is a flash memory.

When power is supplied to the electronic device or the electronic device starts to operate, the booting program and the initialization data are read from the first memory 120 and are stored in the second memory 220 and the third memory 240, respectively.

After the operation 300, the initialization data is sent to the CPU 100 in response to the request signal requesting the initialization data sent from the CPU 100 (operation 302). Specifically, the initialization data stored in the third memory 240 is sent to the CPU 100 in response to the request signal requesting the initialization data.

After the operation 302, the CPU 100 is initialized by using the sent initialization data.

The initialized CPU 100 sends the request signal requesting the booting program to the initialization control unit 200 of the CPU initialization unit 140. The CPU 100 is booted by using the booting program.

As described above, the first memory 120 stores the booting data together with the initialization data, and when power is supplied to the electronic device or when the electronic device restarts to operate, the booting data and the initialization data are stored in the second memory 220 and the third memory 240, respectively. The initialization data is sent to the CPU 100 in response to the request signal of the CPU 100, and therefore, without use of an additional memory to store the initialization data, the CPU 100 can be initialized.

According to the embodiments of the present general inventive concept, the method and apparatus to initialize a CPU, as described above, can initialize the CPU without using a memory such as an EEPROM, and hence reduce the manufacturing costs of an electronic device. Further, since a memory such as an EEPROM for initialization of the CPU is not used, and therefore doesn't need to be programmed, the memory region for the program is not necessary, and therefore the size of a board can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to initialize a central processing unit (CPU), the apparatus comprising:
the CPU to decode a program command of an electronic device and to execute the command;
a first memory to store a booting program to boot the electronic device and initialization data to initialize the CPU; and
a CPU initialization unit to read the booting program and the initialization data from the first memory and to send the booting program and the initialization data to the CPU,
wherein the CPU is initialized by using the initialization data.

2. The apparatus of claim 1, wherein the first memory is a flash memory.

3. The apparatus of claim 1, wherein the CPU initialization unit operates when power is supplied to the electronic device or when the electronic device starts to operate.

4. The apparatus of claim 3, wherein the CPU initialization unit includes:
a second memory to store the booting program read from the first memory;
a third memory to store the initialization data read from the first memory; and
an initialization control unit to control the booting program and the initialization data to be read from the first memory and stored to the second memory and the third memory, respectively, to control the initialization data to be sent to the CPU in response to a request signal requesting the initialization data sent from the CPU, and to control the booting program to be sent to the CPU in response to a request signal requesting the booting program sent from the CPU.

5. A method of initializing a CPU, the method comprising:
reading a booting program to boot an electronic device and initialization data to initialize the CPU, which decodes a program command of the electronic device and executes the command, from a first memory and respectively to store the booting program and the initialization data in a second memory and a third memory;
sending the initialization data to the CPU in response to a request signal requesting the initialization data sent from the CPU; and
initializing the CPU by using the sent initialization data.

6. The method of claim. 5, wherein the operation of initializing the CPU is performed when power is supplied to the electronic device or the electronic device restarts to operate.

7. A central processing unit (CPU) to decode a program of an electronic device and to execute the command, the CPU comprising:
a first memory to store a boot program to boot an electronic device and initialization data to initialize the CPU; and
a CPU initialization unit to read the booting program and the initialization data from the first memory and to initialize the CPU by using the initialization data to the CPU.

8. The apparatus of claim 7, wherein the CPU initialization unit operates when power is supplied to the electronic device or when the electronic device starts to operate.

9. The apparatus of claim 8, wherein the CPU initialization unit includes:
a second memory to store the booting program read from the first memory;
a third memory to store the initialization data read from the first memory; and
an initialization control unit to control the booting program and the initialization data to be read from the first memory and stored to the second memory and the third memory, respectively, to initialize the CPU in response to a request signal generated by the CPU requesting an initialization operation of the CPU, and to boot the electronic device in response to a request signal generated by the CPU requesting a booting operation of the electronic device.

10. A method of initializing a CPU, the method comprising:
reading a booting program to boot an electronic device and initialization data to initialize the CPU, which decodes a program command of the electronic device and executes the command, from a first memory and respectively to store the booting program and the initialization data in a second memory and a third memory; and
initializing the CPU using the stored initialization data in response to a request by the CPU.
